(19) United States
(12) Patent Application Publication
(10) Pub. No.: US 2016/0370752 A1
(43) Pub. Date: Dec. 22, 2016

(54) IMAGE FORMING APPARATUS

(71) Applicant: Konica Minolta, Inc., Tokyo (JP)

(72) Inventor: Keiko MOMOTANI, Osaka (JP)

(21) Appl. No.: 15/177,984

(22) Filed: Jun. 9, 2016

(30) Foreign Application Priority Data
Jun. 18, 2015 (JP) 2015-122508

(51) Int. Cl. G03G 21/00

(52) U.S. Cl. CPC G03G 21/0094

(57) ABSTRACT

An image forming apparatus includes: an image carrier configured to carry a toner image that is formed corresponding to an image using toner with a lubricant externally added thereto; a transfer unit configured to transfer the toner image to a recording material; a cleaning and lubricant-applying unit; and a processor configured to perform supply control, wherein the cleaning and lubricant-applying unit is configured to clean transfer residual toner on the image carrier and to apply the lubricant to the image carrier, and includes a blade, a collected toner holding unit, and a supply member, and the processor is configured to perform control in such a manner that the supply by the supply member is stopped or the amount of supply of the collected toner by the supply member is made smaller.

The entire disclosure of Japanese Patent Application No. 2015-122508 filed on Jun. 18, 2015 including description, claims, drawings, and abstract are incorporated herein by reference in its entirety.

### BACKGROUND OF THE INVENTION

Field of the Invention

The present invention relates to an image forming apparatus such as a copying machine.

Description of the Related Art

An electrophotographic image forming apparatus has means for removing residual toner, such as untransferred toner or transfer residual toner, on an image carrier. A known example of such means is a blade-type cleaning device having a flat blade made of an elastic material, which is configured to remove residual toner on an image carrier by coming into contact with the surface of the image carrier.

In recent years, electrographic image forming apparatuses are required to use smaller-size toner particles for an increase in image quality. Such toner particles are obtained using a polymerization process such as emulsion polymerization or suspension polymerization. Unfortunately, as the size of toner particles decrease, the adhesion between the toner particles and the image carrier increases to make it difficult to remove residual toner from the image carrier.

In particular, polymerized toner particles produced by a polymerization process have a shape close to a sphere. In this case, there is a problem in that the toner particles can roll on the image carrier and slip through the blade so that cleaning failure can be more likely to occur and it can be more difficult to remove residual toner on the image carrier. In addition, if some toner slips through the blade, the toner can serve as a core for the formation of toner aggregates on the image carrier, so that granular white spots (granular noise) can occur in a solid image or a halftone printed image part.

Under present circumstances, in order to address such a quality problem as “granular noise,” a lubricant is supplied onto the image carrier to form a lubricant film, so that cleaning is performed while the adhesion between the toner particles and the image carrier is reduced. Methods for supplying a lubricant onto the image carrier include a lubricant application method including scraping off a lubricant from a lubricant rod with a brush in contact therewith to supply the lubricant to the surface of the image carrier; and an external additive-containing toner method including forming a toner image with toner containing a lubricating external additive (lubricant) to supply the lubricant.

The external additive-containing toner method is advantageous in terms of cost and installation space because it does not need any lubricant rod or applicator such as a blush. Unfortunately, in the external additive-containing toner method, the amount of the lubricant in the developing unit varies with the amount of consumption of the toner, so that the amount of the lubricant film on the image carrier can vary. Specifically, when image printing is performed at a low coverage rate, only the lubricant released from the toner is preferentially consumed for the background part. Since no fresh toner (lubricant) is supplied to the developing unit, the supply and the discharge are finally balanced and stabilized while the developing unit contains a reduced amount of the lubricant.

At the initial stage, a certain level of the lubricant can be kept on the image carrier because only the lubricant can be supplied. However, as the amount of the lubricant in the developing unit decreases, the amount of supply of the lubricant onto the surface of the image carrier decreases, so that the coverage decreases, which can make it impossible to reduce the amount of adhesion to the toner and can lead to the occurrence of granular noise.

At present, a toner image (patch image) is formed on a non-image region of the image carrier in order to maintain the amount of the lubricant in the developing unit at a low coverage rate. When the patch image is formed, a certain amount of toner in the developing unit is consumed, and a certain amount of fresh toner is added to the developing unit. When the toner is added, the lubricant is also added together with the toner, so that the reduction in the amount of the lubricant in the developing unit can be suppressed. As a result, the reduction in the amount of the lubricant on the image carrier can be suppressed. Unfortunately, in this method, the toner is also developed for the purpose other than the image formation and thus wastefully consumed, which is not preferred.

There is another method in which toner is collected at a cleaning unit and then constantly supplied to an upstream part of an image carrier with respect to a blade (see JP 2009-282217 A, JP 2010-128400 A, and JP 2004-109513 A). In this method, a lubricant externally added to the toner is supplied to the part upstream of the blade. In this method, therefore, a reduction in the amount of the lubricant on the image carrier can be prevented during image printing at a low coverage rate, so that granular noise can be suppressed.

However, during image printing at a high coverage rate, the lubricant in the collected toner is also supplied in addition to the lubricant supplied from the developing unit to the image carrier, so that an increased amount of the lubricant is supplied. The increase in the amount of the lubricant on the image carrier can cause the blade to adhere to the image carrier with the lubricant interposed therebetween, which can facilitate wear of the blade to cause a cleaning failure (slipping through of toner).

### SUMMARY OF THE INVENTION

In other words, the amount of the lubricant varies with coverage rate although there is a proper range for the amount of the lubricant on the image carrier. Therefore, there is a need to stabilize the amount of the lubricant. In view of these problems, an object of the present invention is to provide an image forming apparatus capable of reducing coverage rate-dependent variations in the amount of the lubricant on the image carrier.

To achieve the abovementioned object, according to an aspect, an image forming apparatus reflecting one aspect of the present invention comprises: an image carrier configured to carry a toner image that is formed corresponding to an image using toner with a lubricant externally added thereto; a transfer unit configured to transfer the toner image to a recording material; a cleaning and lubricant-applying unit; and a processor configured to perform supply control, wherein the cleaning and lubricant-applying unit is configured to clean transfer residual toner on the image carrier and to apply the lubricant to the image carrier, and comprises a blade configured to clean the transfer residual toner by coming into contact with the image carrier, a collected toner holding unit configured to hold collected toner including toner that has dropped from the blade, and a supply member capable of supplying the collected toner from the holding unit to a part of the image carrier, wherein the part of the image carrier is upstream of the blade with respect to the direction of rotation of the image carrier, and the processor is configured to perform control in such a manner that when the image is printed at a coverage rate higher than a predetermined standard value, the supply by the supply member is stopped or the amount of supply of the collected toner by the supply member is made smaller than that when the coverage rate is not higher than the standard value.

According to the above configuration, it is possible to reduce coverage rate-dependent variations in the amount of the lubricant on the image carrier.

According to the above configuration, the processor is preferably configured to allow the apparatus to perform a first operation when the coverage rate is not higher than the standard value and configured to allow the apparatus to perform a second operation when the coverage rate is higher than the standard value, wherein the first operation comprises allowing the supply member to perform the supply and the second operation comprises collecting the transfer residual toner from the image carrier to the supply member.

According to the above configuration, the image forming apparatus further preferably comprises at least one of a charging unit configured to charge toner on the image carrier before the collection and a charging unit configured to charge toner on the supply member before the supply, and the processor is preferably configured to switch between the first operation and the second operation by switching the voltage of the supply member.

According to the above configuration, the image forming apparatus further preferably comprises a toner feed member configured to supply the collected toner to the supply member by rotating and coming into contact with the supply member, and the processor is preferably configured to control at least one of switching between rotation and stop of the toner feed member, the rotation speed of the toner feed member, and switching between contact and separation between the toner feed member and the supply member.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic diagram of an image forming apparatus according to a first embodiment;

FIG. 2 is a diagram for illustrating edge contact of a blade BL;

FIG. 3 is a schematic diagram of an image forming apparatus according to a second embodiment;

FIG. 4 is a schematic diagram of an image forming apparatus according to a third embodiment;

FIG. 5 is a schematic diagram of an image forming apparatus according to a fourth embodiment;

FIG. 6 is a diagram for illustrating the movement of a lubricant; and

FIG. 7 is a diagram for illustrating the movement of a lubricant.

### DESCRIPTION OF THE PREFERRED EMBODIMENTS

Hereinafter, an embodiment of the present invention will be described with reference to the drawings. However, the scope of the invention is not limited to the illustrated examples.

### 1. First Embodiment

Now, a first embodiment of the present invention will be described. FIG. 1 shows the main structure of a monochromatic image forming apparatus according to this embodiment.

As shown in the drawing, the image forming apparatus includes a drum-shaped photoreceptor 1, which is a rotatable image carrier; a charging unit 2 configured to uniformly charge the surface of the photoreceptor 1; an exposure unit 3 configured to form an electrostatic latent image by light exposure of the surface of the photoreceptor 1 charged by the charging unit 2; a developing unit 4 configured to visualize, with a toner-containing developer, the latent image formed by the exposure unit 3; a transfer unit 5 configured to transfer the toner image, which is formed on the photoreceptor 1, to a recording material in a transfer region; and a cleaning and lubricant-applying unit 8 configured to remove toner on the photoreceptor 1 after the toner passes through the transfer region.

The photoreceptor 1 is, for example, an organic photoreceptor including a drum-shaped metal substrate and a photosensitive layer that is formed on the outer surface of the metal substrate and includes an organic photoconductor-containing resin. Examples of the resin used to form the photosensitive layer include polycarbonate resin, silicone resin, polystyrene resin, acrylic resin, methacrylic resin, epoxy resin, polyurethane resin, vinyl chloride resin, and melamine resin.

The charging unit 2 charges the photoreceptor 1 to a certain potential by using an electrostatic charger. Subsequently, the exposure unit 3 such as a laser forms an electrostatic latent image on the surface of the photoreceptor 1. The developing unit 4 includes a developing sleeve 4a opposed to the photoreceptor 1 with a development region interposed therebetween. For example, a DC developing bias with the same polarity as the charge polarity of the charging unit 2 or a developing bias obtained by superimposing an AC voltage on a DC voltage with the same polarity as the charge polarity of the charging unit 2 is applied to the developing sleeve 4a to perform reversal development in which toner is deposited on the electrostatic latent image formed by the exposure unit 3.

The photoreceptor 1 is rotated so that the toner image formed on the photoreceptor 1 by the developing unit 4 is transferred to a transfer region formed between the transfer unit 5 and the photoreceptor 1. In the transfer region, a voltage with a polarity reverse to that of the toner is generally applied to the transfer unit 5 to allow the toner image on the photoreceptor 1 to be transferred onto a recording material (such as a print sheet). The recording material with the image transferred thereto is then fed to a fixing unit (not shown), from which the fixed image is output.

The toner residue, which is not transferred to the recording material in the transfer region and remains on the photoreceptor 1, is fed to the cleaning and lubricant-applying unit 8. The photoreceptor 1, from which the toner on the surface is collected by the cleaning and lubricant-applying unit 8, is charged again by the charging unit 2 and then subjected to another cycle in which the next electrostatic latent image and then the next toner image are formed.

The cleaning and lubricant-applying unit 8 includes a flat blade 81 made of an elastic material, a collected toner holding unit 82 configured to hold the collected toner that has dropped from the blade 81, a supply member 83 configured to supply (capable of supplying) lubricant-bearing toner from the collected toner holding unit 82 to a part of the photoreceptor, wherein the part of the photoreceptor is upstream of the blade 81 with respect to the direction of rotation of the photoreceptor. The blade 81 comes into contact with the photoreceptor 1 in the counter direction to scrape the transfer residual toner for the collection and cleaning of the residual toner and to apply, to the photoreceptor 1, the lubricant externally added to the toner.

The important physical properties of the blade 81 include modulus of repulsion elasticity and hardness. The blade 81 preferably has a modulus of repulsion elasticity of 10 to 80%, more preferably 30 to 70%, at a temperature of 25° C. The blade 81 preferably has a JIS A hardness of 20 to 90°, more preferably 60 to 80°. The blade 81 with a JIS A hardness of less than 20° may be so soft as to easily curl up. On the other hand, if the blade 81 has a JIS A hardness of more than 90°, it can be difficult for the blade 81 to follow small irregularities or foreign particles on the photoreceptor 1, so that toner particles may be more likely to slip through the blade 81 even when a proper amount of the lubricant is supplied.

The contact load from the blade 81 to the photoreceptor 1 is preferably 0.1 to 40 N/m, more preferably 1 to 25 N/m. If the contact load is less than 0.1 N/m, the cleaning power may be insufficient so that image stain may be more likely to occur. On the other hand, a contact load of more than 40 N/m can increase the wear of the photoreceptor 1 to make thin spots and other defects more likely to occur in the image. The measurement of the contact load can be performed using a method of pressing the front end of the blade 81 against a balance or a method of electrically measuring the load with a sensor such as a load cell located at the position where the front end of the blade 81 comes into contact with the photoreceptor 1.

The collected toner holding unit 82 is configured to hold the collected toner, which is scraped off by the blade 81, and to enable the collected toner to be supplied to the supply member 83. The collected toner holding unit 82 has a mechanism for discharging the toner so that the toner can be discharged to the outside when the amount of the toner in the collected toner holding unit 82 becomes larger than necessary.

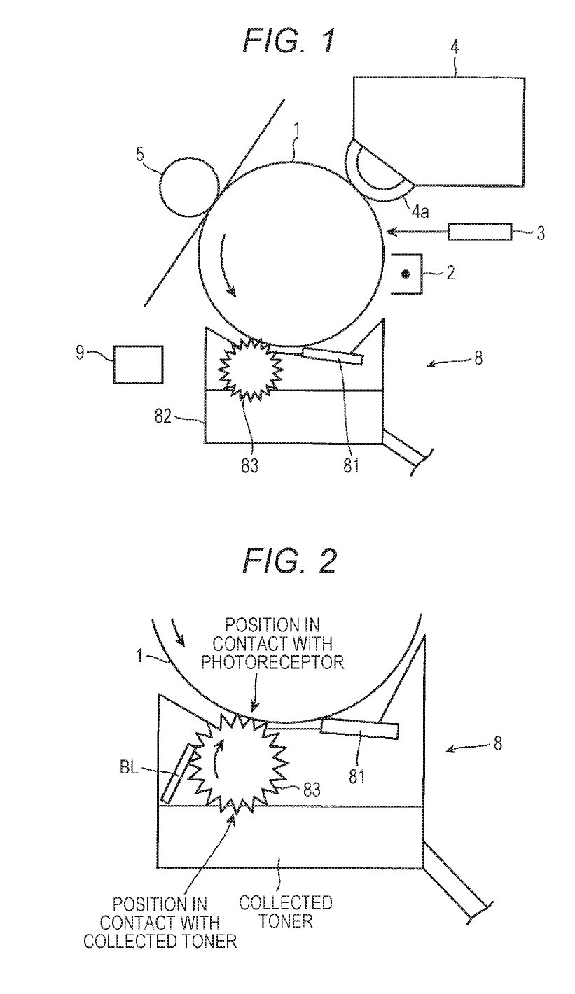

The supply member 83 includes a rotary member capable of holding the toner. The supply member 83 comes into contact with the collected toner in its rotation direction and then into contact with the photoreceptor 1 so that the collected toner can be supplied to the photoreceptor 1. The supply member 83 has a surface layer made of a brush, a sponge, an elastic material, a metal, a resin, or the like. The surface layer made of an elastic material, a metal, or a resin may also have projections and depressions. In order to stabilize the amount of supply, a film, a blade, or any other member may be brought into surface or edge contact with a part of the supply member 83, in which the part of the supply member 83 is downstream of the position in contact with the collected toner and upstream of the position in contact with the photoreceptor. FIG. 2 shows an example of such a structure in which a blade BL is brought into edge contact with the supply member 83.

Next, toner for use in this embodiment will be described. The toner contains at least a lubricant. Examples of the lubricant include, but are not limited to, a fatty acid metal salt, a silicone oil, and a fluororesin. These materials may be used alone or in mixture of two or more. A fatty acid metal salt is particularly preferred. Concerning the fatty acid metal salt, the fatty acid preferably has a linear hydrocarbon moiety. For example, the fatty acid is preferably myristic acid, palmitic acid, stearic acid, or oleic acid, more preferably stearic acid.

The metal may be, for example, lithium, magnesium, calcium, strontium, zinc, cadmium, aluminum, cerium, titanium, or iron. Among them, zinc stearate, magnesium stearate, aluminum stearate, or iron stearate is preferred, and zinc stearate is most preferred (in examples of this embodiment described below, 0.2 parts by weight of zinc stearate is added based on the weight of the toner for use in an experiment to show the effect).

The image forming apparatus of this embodiment is configured to perform a process that includes acquiring information about the image X to be printed on a recording material (for example, allowing a scanner (not shown) to scan the document to acquire image information), forming a toner image, which corresponds to the image X, on the photoreceptor 1 by using toner with a lubricant externally added thereto, and transferring the toner image to the recording material. In addition, the image forming apparatus is so configured that when the coverage rate for the image X exceeds a predetermined standard value (hereinafter referred to as “when the coverage rate is high”), the supply of the collected toner by the supply member 83 is stopped or the amount of supply of the collected toner by the supply member 83 is made smaller than that when the coverage rate does not exceed the standard value (hereinafter referred to as “when the coverage rate is low”).

Such control is performed by a control unit 9 (for example, including an electric circuit such as a processor) in the image forming apparatus. Alternatively, the control unit 9 may also be configured to allow the supply member 83 to supply the collected toner when the coverage rate is low and to allow the blade 81 to collect the transfer residual toner when the coverage rate is high.

### 2. Second Embodiment

Next, a second embodiment of the present invention will be described. In the description below, emphasis will be placed on the description of features different from those in the first embodiment while the description of some common features will be omitted.

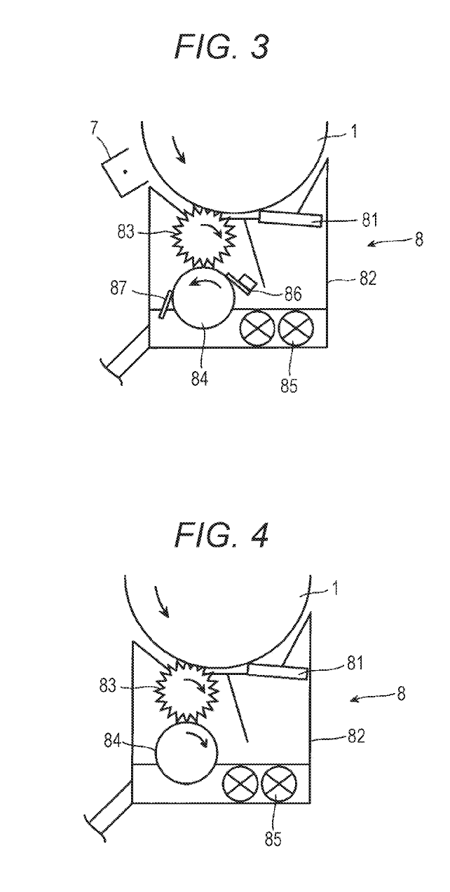

FIG. 3 is a schematic diagram of a cleaning and lubricant-applying unit 8 and peripherals thereof according to the second embodiment. The residual toner, which is not transferred onto the recording material in the transfer region and remains on the photoreceptor 1, is allowed to pass through a residual toner charging unit 7 including a scorotron charger so that the charge polarity of the toner is made constant.

The residual toner charging unit 7 is not limited to this type and may be of any type capable of controlling the amount of charge on the toner before and after the passage, such as a corotron charger using corona discharge, a scorotron charger, a discharge needle, a discharge fabric including a nonwoven fabric or the like, an electrode or roller opposed to the image carrier with a very small gap therebetween, or a contact type roller. The applied voltage may be DC, AC, or AC superimposed on DC.

The residual toner charging unit 7, which is means for making the charge polarity of the toner constant before the toner reaches the supply member 83, may be located at any position downstream of the development position and upstream of the supply member 83. The charged toner is fed to a cleaning and lubricant-applying unit 8.

The cleaning and lubricant-applying unit 8 includes a blade 81, a collected toner holding unit 82, a supply member 83 including a conductive brush roller, a feed member 84 capable of supplying the collected toner to the supply member 83, a stirring mechanism 85 configured to stir the collected toner, a collected toner charging unit 86 configured to charge the toner by coming into contact with the feed member 84, and a scraper 87 configured to scrape the toner on the feed member 84. A partition is also provided between the blade 81 and the supply member 83 to prevent the collected toner from adhering directly to the supply member 83 after the toner is scraped off by the blade 81.

The stirring mechanism 85 includes two screws each having a spiral partition in the axial direction, in which the screws are moved to feed the toner in directions opposite to each other along the axial direction. The stirring is performed to ensure a uniform lubricant content even when there are variations in the amount of the attached lubricant in the collected toner. The stirring mechanism is not limited to this type and may be of any other type capable of ensuring a uniform lubricant content by stirring the collected toner.

The feed member 84 includes a conductive elastic roller. The feed member 84 is configured to allow the collected toner to be supplied to the supply member 83 by coming into contact with the collected toner and then into contact with the supply member 83 in the direction of rotation of the supply member 83. The feed member 84 is not limited to this type and may be of any other type capable of holding and feeding the toner. For example, the feed member 84 may have a surface layer made of a brush, a sponge, an elastic material, a metal, a resin, or a fabric, and the surface layer made of each material may also have projections and depressions.

The collected toner charging unit 86 has a conductive film provided in contact with a part of the feed member 84 to apply a voltage for charging the collected toner, in which the part of the feed member 84 is downstream of the position in contact with the collected toner and upstream of the position in contact with the supply member. This makes the charge polarity of the collected toner constant when the collected toner is supplied to the supply member 83, so that the toner can be easily transferred by the electric field control described below.

The collected toner charging unit 86 is not limited to this type and may be of any other type capable of controlling the amount of charge on the collected toner to be supplied to the photoreceptor 1. For example, the collected toner charging unit 86 may have a fixed or rotatable conductive brush, conductive elastomer, conductive resin, or conductive fabric that is placed opposite to and in contact with or in the vicinity of the feed member 84 to apply a voltage. The collected toner charging unit 86 may also be of any other type capable of controlling the amount of charge on the toner before and after the passage, such as a corotron charger using corona discharge, a scorotron charger, or a discharge needle. The applied voltage may be DC, AC, or AC superimposed on DC.

The collected toner charging unit 86 is means for controlling the amount of charge on the toner before the toner reaches the photoreceptor 1. Alternatively, therefore, the collected toner charging unit 86 may be located at the supply member 83. A scraper 87 may be optionally provided to remove the collected residual toner from the feed member 84 so that the toner can be evenly attached to the feed member 84, which makes it easy to stabilize the feed amount.

Next, a method for controlling the amount of supply in the second embodiment will be described. Although not shown, a voltage application unit is provided to apply a desired voltage to the feed member 84 and the supply member 83. The collected toner is conveyed by the feed member 84 and then charged to a negative polarity by the collected toner charging unit 86. The residual toner on the photoreceptor 1 is also charged to a negative polarity by the residual toner charging unit 7.

First, a method for supplying, from the supply member 83 to the photoreceptor 1, toner with a lubricant externally added thereto will be described. This method (control) is performed, for example, when the coverage rate is low for the image X to be printed on a recording material. A voltage negatively larger than the surface potential of the photoreceptor is applied to the supply member 83. Specifically, when the surface potential of the photoreceptor is −400 V, for example, −600 V is applied to the supply member 83. A voltage negatively larger than that of the supply member 83 is also applied to the feed member 84.

Specifically, when the voltage of the supply member 83 is −600 V, for example, −800 V is applied to the feed member 84. The collected toner controlled to have a negative polarity on the feed member 84 is transferred to the supply member 83 by the electric field between the feed member 84 and the supply member 83. After transferred to the supply member 83, the collected toner is fed to the position facing the photoreceptor 1 and then transferred to the photoreceptor 1 by the electric field between the supply member 83 and the surface of the photoreceptor 1.

On the other hand, the transfer residual toner on the photoreceptor 1 remains deposited on the photoreceptor 1 and passes through the position facing the supply member 83 without being transferred to the supply member 83 by the electric field. As the photoreceptor 1 moves, the collected toner and the transfer residual toner reaches the blade 81. As a result, the lubricant attached to the toner is supplied to the blade 81, and the lubricant released from the toner reaches the position at which the blade 81 is in contact with the photoreceptor 1, so that the lubricant is applied to the photoreceptor 1 under the pressure from the blade while providing a good cleaning ability.

Next, a method for collecting the transfer residual toner without supplying, from the supply member 83 to the photoreceptor 1, the toner with a lubricant externally added thereto. This method (control) is performed, for example, when the coverage rate is high for the image X to be printed on a recording material.

A voltage negatively smaller than the surface potential of the photoreceptor is applied to the supply member 83. Specifically, when the surface potential of the photoreceptor is −400 V, for example, −200 V is applied to the supply member 83. A voltage negatively smaller than that of the supply member 83 is also applied to the feed member 84. Specifically, when the voltage of the supply member 83 is −200 V, for example, 0 V is applied to the feed member 84.

The collected toner controlled to have a negative polarity on the feed member 84 remains on the feed member 84 without being transferred to the supply member 83 by the electric field between the feed member 84 and the supply member 83. Therefore, the collected toner is not supplied from the supply member 83 to the photoreceptor 1. On the other hand, when the transfer residual toner on the photoreceptor 1 reaches the position facing the supply member 83, the transfer residual toner is transferred to the supply member 83 by the electric field between the surface of the photoreceptor 1 and the supply member 83. After transferred to the supply member 83, the transfer residual toner is fed to the position facing the feed member 84. Subsequently, the transfer residual toner is transferred to the feed member 84 by the electric field between the feed member 84 and the supply member 83 and then scraped off by the scraper 87. As a result, a reduced amount of the transfer residual toner is supplied to the blade 81 with no supply of the collected toner to the blade 81.

In the above description, each voltage difference is expressed as 200 V. However, the applied voltage may be adjusted, as appropriate, taking into account the resistance of the member and other properties, and AC may also be superimposed on the voltage. The amount of the transfer can also be controlled by controlling the voltage difference. As described above, the amount of supply of the collected toner and the amount of collection of the transfer residual toner can be controlled by using the residual toner charging unit, the collected toner charging unit, supply member voltage control, and feed member voltage control.

### 3. Third Embodiment

Next, a third embodiment of the present invention will be described. In the description below, emphasis will be placed on the description of features different from those in the second embodiment while the description of some common features will be omitted.

FIG. 4 is a schematic diagram of a cleaning and lubricant-applying unit 8 and peripherals thereof according to the third embodiment. The cleaning and lubricant-applying unit 8 includes a blade 81, a collected toner holding unit 82, a supply member 83 including a brush roller, a feed member 84 capable of supplying the collected toner to the supply member 83, and a stirring mechanism 85 configured to stir the collected toner. A partition is also provided between the blade 81 and the supply member 83 to prevent the collected toner from adhering directly to the supply member 83 after the toner is scraped off by the blade 81. The third embodiment differs from the second embodiment in that it does not includes the residual toner charging unit, the collected toner charging unit, the supply member voltage control unit, or the feed member voltage control unit. The feed member 84 is so configured that its rotation speed is controllable.

Next, a method for controlling the amount of supply according to the third embodiment will be described. First, a method for supplying, from the supply member 83 to the photoreceptor 1, toner with a lubricant externally added thereto will be described. This method (control) is performed, for example, when the coverage rate is low for the image X to be printed on a recording material.

The collected toner on the feed member 84 is rubbed by the supply member 83 including a rotary fur brush being in contact with the toner, so that the toner is mostly transferred to the supply member 83. After transferred to the supply member 83, the collected toner is fed to the position facing the photoreceptor 1 and then mostly transferred to the photoreceptor 1 by rubbing between the supply member 83 and the surface of the photoreceptor 1 being in contact with each other.

On the other hand, the transfer residual toner on the photoreceptor 1 is partially transferred to the supply member 83 by rubbing at the position facing the supply member 83. After transferred to the supply member 83, the transfer residual toner is fed to the position facing the feed member 84 but not transferred to the feed member 84 because of the presence of the collected toner on the feed member 84. Therefore, the transfer residual toner is fed to the position in contact with the photoreceptor 1 and then transferred to photoreceptor 1 while being mixed with the collected toner.

Through this series of processes, the collected toner and the transfer residual toner reach the blade 81 as the photoreceptor 1 rotates. As a result, the lubricant attached to the toner is supplied to the blade 81, and the lubricant released from the toner reaches the position at which the blade 81 is in contact with the photoreceptor 1, so that the lubricant is applied to the photoreceptor 1 under the pressure from the blade while providing a good cleaning ability.

Next, a method for stopping the toner supply (supplying, from the supply member 83 to the photoreceptor 1, the toner with the lubricant externally added thereto) will be described. This method (control) is performed, for example, when the coverage rate is high for the image X to be printed on a recording material.

The driving of the feed member 84 is stopped. The collected toner at the position where the feed member 84 is in contact with the supply member 83 is entirely scraped off during a period when the supply member 83 rotates several times, after which no toner is supplied from the feed member 84 to the supply member 83. On the other hand, the transfer residual toner on the photoreceptor 1 is partially transferred to the supply member 83 by rubbing at the position facing the supply member 83.

After transferred to the supply member 83, the transfer residual toner is fed to the position facing the feed member 84 and then partially flicked from the brush when coming into contact with the stationary feed member 84 (flicker effect). The transfer residual toner remaining on the supply member 83 is returned again to the position facing the photoreceptor 1 and then partially transferred to the photoreceptor 1. Due to this series of processes, the collected toner is not supplied from the supply member 83. In addition, due to the flicker effect, the amount of the transfer residual toner on the photoreceptor 1 is made smaller after the supply member 83 passes through the contact position than before.

The above description shows an example using the drive and stop of rotation of the feed member 84. Alternatively, a method of controlling the rotation speed may also be used. Specifically, the amount of supply is increased and decreased by increasing and decreasing the rotation speed of the feed member 84.

The feed may also be stopped by a method of separating the feed member 84 from the supply member 83. In the second and third embodiments, the feed member 84 is provided. Alternatively, the feed member 84 may be omitted as in the first embodiment, and the collected toner may be directly supplied to the supply member 83 through contact. In this case, the voltage control only includes controlling the voltage of the supply member 83. The drive control includes controlling the rotation speed of the supply member 83 and controlling the contact with and separation from the photoreceptor 1.

### 4. Fourth Embodiment

Next, a fourth embodiment of the present invention will be described. In the description below, emphasis will be placed on the description of features different from those in the first embodiment while the description of some common features will be omitted.

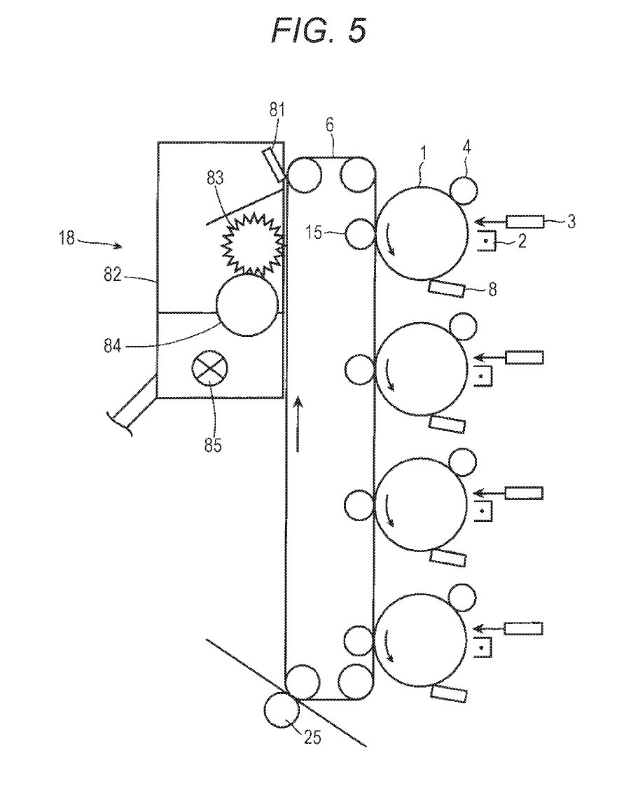

FIG. 5 schematically shows the structure of an image forming apparatus according to the fourth embodiment. The image forming apparatus includes a photoreceptor 1, a charging unit 2, an exposure unit 3, a developing unit 4, and a cleaning and lubricant-applying unit 8 configured to remove toner on the photoreceptor 1, which are the same as those shown in FIG. 1. In the fourth embodiment, a set of these units is provided for each of colors (e.g., four colors such as cyan, magenta, yellow, and black) to make color printing possible.

The toner image formed on the photoreceptor 1 is not directly transferred to a transfer material but transferred to an intermediate transfer member 6 in a transfer unit 15. After transferred to the intermediate transfer member 6, the toner image is transferred to a recording material at a secondary transfer position 25. Subsequently, the toner image is fed to a fixing unit (not shown) and then fixed on the recording material. In this embodiment, a cleaning and lubricant-applying unit 18 is provided to remove the toner on the intermediate transfer member 6 after the intermediate transfer member 6 passes through the transfer region.

The external addition of a lubricant to the toner and the supply of the added lubricant to the blade are effective in not only improving the ability to clean the photoreceptor 1 but also improving the ability to clean the intermediate transfer member 6. In this embodiment, the cleaning and lubricant-applying unit 18 is provided in order to improve the ability to clean the intermediate transfer member 6. This unit also serves to stabilize the amount of supply of the lubricant to the intermediate transfer member 6 by the same structure and mechanism as the cleaning and lubricant-applying unit 8 in the first embodiment (or in the second or third embodiment).

### 5. Movement of Lubricant

Next, the movement of the lubricant in this embodiment will be described. As mentioned above, the lubricant reaches not only an upstream part of the photoreceptor 1 with respect to the blade 81 but also an upstream part of the intermediate transfer member 6 with respect to the position where the cleaning is performed.

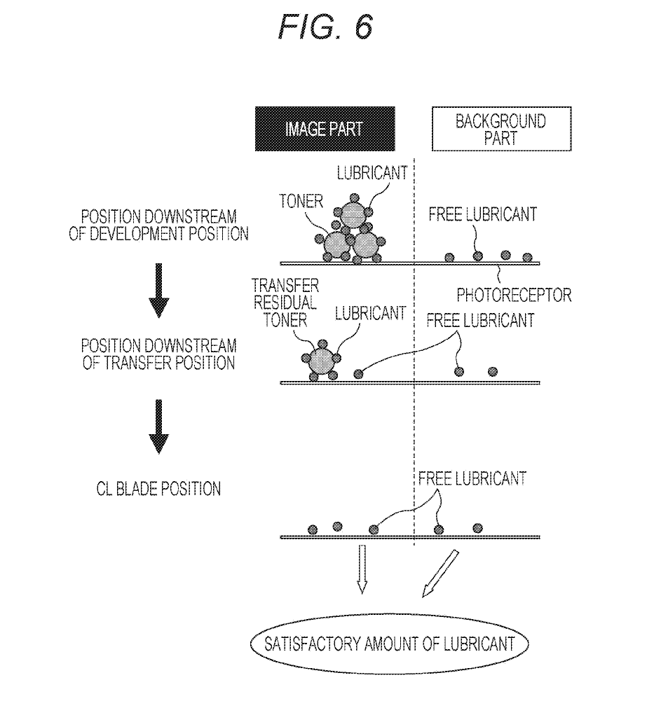

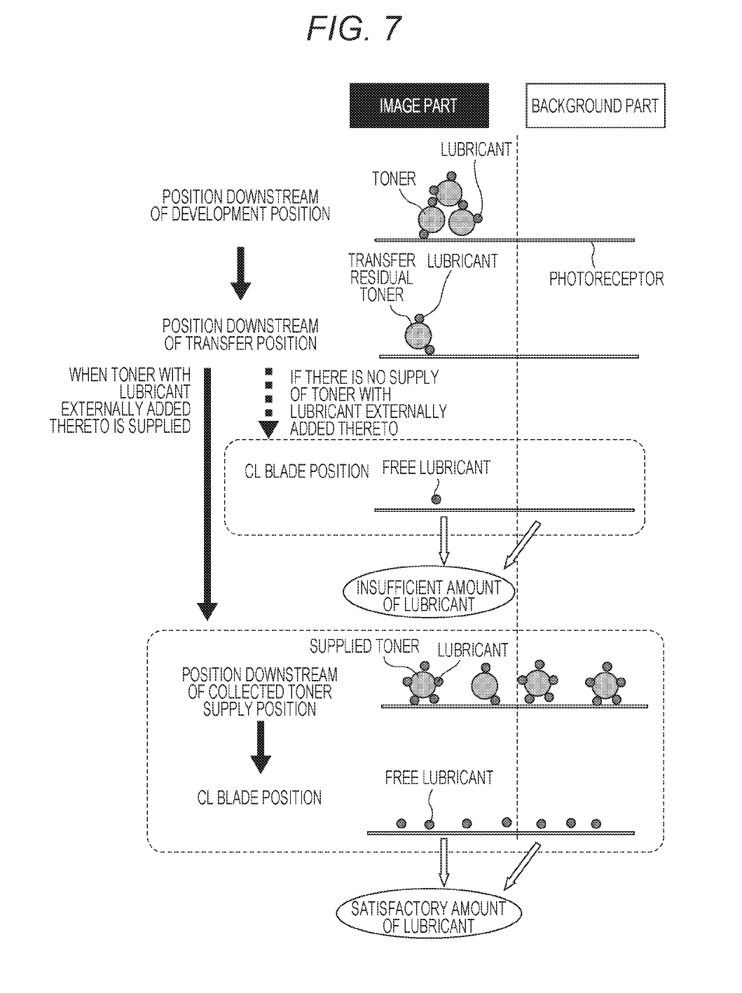

During the initial operation or continuous printing at a high coverage rate, the amount of the lubricant reaching the part is satisfactory (not insufficient) even when the toner with the lubricant externally added thereto is not supplied from the supply member 83. In order to facilitate the understanding of the reason, FIG. 6 schematically shows how the lubricant moves in the image and background parts on the photoreceptor 1 (during the initial printing or continuous printing at a relatively high coverage rate). In FIG. 6 (also in FIG. 7 described below), how the lubricant moves in the image part is shown on the left of the broken line, while how the lubricant moves in the background part is shown on the right of the broken line.

As shown in the drawing, at the position downstream of the development position, the lubricant externally added to the toner and the free lubricant are present in a relatively large amount in the image and background parts, respectively. Also at the position of the cleaning (CL) blade downstream of the transfer position, the free lubricant is present in a relatively large amount, which means that the amount of the lubricant is satisfactory.

On the other hand, the amount of discharge of the lubricant from the developing unit 4 is small during continuous printing at a low coverage rate. In this case, the lubricant will be short if the toner with the lubricant externally added thereto is not supplied from the supply member 83. In order to facilitate the understanding of the reason, FIG. 7 schematically shows how the lubricant moves in the image and background parts on the photoreceptor 1 (during continuous printing at a low coverage rate).

As shown in the drawing, the amount of the lubricant externally added to the toner and the amount of the free lubricant are relatively small at the position downstream of the development position. Therefore, if the toner with the lubricant externally added thereto is not supplied (see the broken line arrow in FIG. 7), the amount of the free lubricant will also be very small at the position of the CL blade so that the amount of the lubricant will be insufficient. In this embodiment, however, the toner with the lubricant externally added thereto is supplied by the supply member 83, so that the free lubricant will be present in a relatively large amount at the position of the CL blade, which means that the amount of the lubricant will be satisfactory. In this embodiment, therefore, the amount of the lubricant can be kept satisfactory even when printing at a low coverage rate is continued.

This section has shown an exemplary case where the image carrier is the photoreceptor 1. It will be understood, however, that a satisfactory amount of the lubricant can also be maintained on the intermediate transfer member 6 based on the same principle as shown in FIG. 7 when a cleaning and lubricant-applying unit 18 is provided for the intermediate transfer member 6 as in the fourth embodiment.

### 6. Comparative Verification with Examples

In order to examine the effects of the above embodiments, each example was performed as described below and compared and verified with comparative examples. Each example was performed using the photoreceptor, the developing unit, the transfer unit, the toner, the blade, and other settings described below.

(1) Photoreceptor

The photoreceptor 1 used is a drum-shaped organic photoreceptor including a drum-shaped aluminum metal substrate and a 25-μm-thick photosensitive layer including a polycarbonate resin and formed on the outer surface of the substrate. The photoreceptor is rotated at 400 mm/sec.

(2) Developing Unit

The developing unit 4 used includes a developing sleeve rotatable at a line speed of 600 mm/min and is so configured that a bias voltage with the same polarity as that of the surface potential of the photoreceptor 1 is applied to the developing sleeve for reversal development with a two-component developer. The toner constituting the two-component developer includes negatively-chargeable toner particles with a volume average particle size of 6.5 μm produced by emulsion polymerization.

(3) Transfer Unit

An endless belt 6 including a polyimide resin having electrical conductivity is used as the intermediate transfer member. Transfer rollers 15 each pressed against the photoreceptor 1 with the belt 6 interposed therebetween are provided to apply a voltage generally with a polarity reverse to the charge polarity of the toner.

(4) Cleaning and Lubricant-Applying Unit

The blade 81 used is made of urethane rubber and has a modulus of repulsion elasticity of 50% (25° C.), a JIS A hardness of 70°, a thickness of 2.00 mm, a free length of 10 mm, and a width of 324 mm. The contact load from the blade 81 to the photoreceptor 1 is set to 20 N/m, and the contact angle between the blade 81 and the photoreceptor 1 is set to 15°. The supply member 83 used includes a conductive fur brush including conductive nylon fibers (resistance 10⁸Ω, thickness 20 μm, fiber density 3.0×10⁸/m²) and having a brush hair length of 3 mm and a roller diameter of 14 mm. The feed member 84 used is a conductive rubber roller with a diameter of 14 mm including a metal core and a 2-mm-thick rubber layer that is placed around the core, composed of NBR and carbon dispersed therein, and has a volume resistance of 1×10⁶ Ω·cm.

(5) Toner

The toner constituting a two-component developer is negatively chargeable and includes toner particles with a volume average particle size of 6.5 μm produced by emulsion polymerization. The toner used contains 0.2 parts of zinc stearate as a lubricant, which is added to the toner particles, based on the amount of the toner.

Under the conditions shown above, the surface potential V₀ of the photoreceptor 1 in the non-exposure region was set to −750 V, the surface potential Vi of the photoreceptor 1 in the exposure region was set to −100 V, and a developing bias with a frequency of 6,000 Hz, an amplitude of 800 V, and a DC component of −550 V was applied to the developing sleeve 4a. The primary transfer voltage was set to +500 V to achieve a transfer efficiency of 95% or more.

The following conditions for the evaluation of the cleaning ability were common for the respective examples. The environmental conditions were fixed at 30° C. and a humidity of 85%. Printing on one sheet, continuous printing on 1,000 sheets, and continuous printing on 100,000 sheets were each performed at coverage rates of 2%, 10%, 50%, and 90%. Under each set of conditions, an examination was performed in which the evaluation item was whether or not noise caused by slipping-through of toner occurred as a cleaning defect on the image. The evaluation results are represented as follows. A: No slipping-through of toner occurs (practically acceptable). B: Slipping-through of toner occurs (practically unacceptable).

Immediately after continuous printing was performed under each set of conditions, a halftone image was printed at a coverage rate of 70% on one sheet. At this time, an examination was also performed in which the evaluation item was whether or not granular unevenness occurred. The evaluation results are represented as follows. A: No granular unevenness occurs (practically acceptable). B: Granular unevenness occurs (practically unacceptable).

First, Example 1 corresponding to the second embodiment described above will be more specifically described. More specifically, conditions for the example and comparative examples were set as follows, respectively.

Residual toner charging unit 7: Scorotron charger (the surface potential of the photoreceptor is −400 V after the passage)

Collected toner charging unit 86: Conductive film (a voltage of −500 V is applied to the feed member)

Scraper 87: SUS sheet (at the same potential as that of the feed member)

Rotation of the supply member 83: Co-driving with the photoreceptor 1 with a rotation speed difference θ of 1.3 between the supply member 83 and the photoreceptor 1

Rotation of feed member 84: Co-driving with the supply member 83 with a rotation speed difference θ of 0.8 between the feed member 84 and the supply member 83

Voltage applied to the supply member: As shown in Table 1

Voltage applied to the feed member: As shown in Table 1

Table 1 below shows the results of the evaluation in Example 1. In this example, the voltage was controlled depending on coverage rate according to the gist of the second embodiment. The “voltage control” column of Table 1 shows values for (the voltage applied to the supply member 83)/(the voltage applied to the feed member 84).

TABLE 1

| | | Voltage control | | | |
|---|---|---|---|---|---|
| | | −200 V/ | −100 V/ | 0 V/ | 50 V/ |
| | | −300 V | −200 V | 0 V | 100 V |
| | | Coverage rate | | | |
| Conditions | | 2% | 10% | 50% | 90% |
| Number of | 1 | A | A | A | A |
| sheets | 1,000 | A | A | A | A |
| | 100,000 | A | A | A | A |

As shown in Table 1, good results were obtained at all coverage rates in Example 1.

Table 2 below shows the results of the evaluation in Comparative Example 1 for comparison with Example 1. In Comparative Example 1, the voltages of the supply member 83 and the feed member 84 were fixed at −100 V and −200 V, respectively, regardless of coverage rate.

TABLE 2

| | Voltage control | −100 V/−200 V (constant supply) | | | |
|---|---|---|---|---|---|
| Conditions | Coverage rate | 2% | 10% | 50% | 90% |
| Number of | 1 | A | A | A | A |
| sheets | 1,000 | A | A | A | A |
| | 100,000 | A | A | A | B: Slipping |
| | | | | | through |

As shown in Table 2, the problem of slipping-through occurred as a result of printing on 100,000 sheets at a high coverage rate (90%) in Comparative Example 1.

Table 3 below shows the results of the evaluation in Comparative Example 2 for comparison with Example 1. In Comparative Example 2, the supply member 83 and the feed member 84 were omitted.

TABLE 3

| | With no supply member or feed member | | | | |
|---|---|---|---|---|---|
| | Coverage | | | | |
| Conditions | rate | 2% | 10% | 50% | 90% |
| Number of | 1 | A | A | A | A |
| sheets | 1,000 | B: Granular | A | A | A |
| | | unevenness | | | |
| | 100,000 | B: Granular | B: Granular | A | A |
| | | unevenness | unevenness | | |

As shown in Table 3, the problem of granular unevenness occurred as a result of printing on at least 1,000 sheets at a low coverage rate (2%) and as a result of printing on 100,000 sheets at a low coverage rate (10%) in Comparative Example 2.

Next, Example 2 corresponding to the third embodiment described above will be more specifically described. Conditions for the example and comparative examples were set as follows, respectively. •Rotation of the supply member 83: Co-driving with the photoreceptor 1 with a rotation speed difference of 1.3 between the supply member 83 and the photoreceptor 1 •Rotation of the feed member 84: Counter-driving against the supply member 83 with the rotation speed difference θ between the feed member 84 and the supply member 83 shown in the table •Voltage applied to the supply member 83: Float•Voltage applied to the feed member 84: Float

Table 4 below shows the results of the evaluation in Example 2. In this example, the driving was controlled depending on coverage rate according to the gist of the third embodiment. The “driving control” column of Table 4 shows the value of the rotation speed difference θ between the feed member 84 and the supply member 83. The term “Driving OFF” means that the feed member 84 is not driven.

TABLE 4

| | | Driving control | | | |
|---|---|---|---|---|---|
| | | θ = 1.5 | θ = 1 | θ = 0.5 | Driving OFF |
| | | Coverage rate | | | |
| Conditions | | 2% | 10% | 50% | 90% |
| Number of | 1 | A | A | A | A |
| sheets | 1,000 | A | A | A | A |
| | 100,000 | A | A | A | A |

As shown in Table 4, good results were obtained at all coverage rates in Example 2.

Table 5 below shows the results of the evaluation in Comparative Example 3 for comparison with Example 2. In Comparative Example 3, the rotation speed difference θ between the feed member 84 and the supply member 83 was fixed at 1 regardless of coverage rate.

TABLE 5

| | Driving control | θ = 1 (constant supply) | | | |
|---|---|---|---|---|---|
| Conditions | Coverage rate | 2% | 10% | 50% | 90% |
| Number of | 1 | A | A | A | A |
| sheets | 1,000 | A | A | A | A |
| | 100,000 | A | A | A | B: Slipping |
| | | | | | through |

As shown in Table 5, the problem of slipping-through occurred as a result of printing on 100,000 sheets at a high coverage rate (90%) in Comparative Example 3.

Table 6 below shows the results of the evaluation in Comparative Example 4 (similar to Comparative Example 2) for comparison with Example 2. In Comparative Example 4, the supply member 83 and the feed member 84 were omitted.

TABLE 6

| | With no supply member or feed member | | | | |
|---|---|---|---|---|---|
| Conditions | Coverage rate | 2% | 10% | 50% | 90% |
| Number of | 1 | A | A | A | A |
| sheets | 1,000 | B: Granular | A | A | A |
| | | unevenness | | | |
| | 100,000 | B: Granular | B: Granular | A | A |
| | | unevenness | unevenness | | |

As shown in Table 6, the problem of granular unevenness occurred as a result of printing on at least 1,000 sheets at a low coverage rate (2%) and as a result of printing on 100,000 sheets at a low coverage rate (10%) in Comparative Example 4.

The evaluation results described above show the following. The problem of image unevenness (granular unevenness) or noise caused by slipping-through of toner occurred in each comparative example. In contrast, good images were obtained with no shortage or excess of the amount of the lubricant during both continuous printing at a low coverage rate and continuous printing at a high coverage rate in the examples according to embodiments of the present invention.

### 7. Overview

As described above, the image forming apparatus according to an embodiment of the present invention is configured to form, on an image carrier, a toner image corresponding to an image using toner with a lubricant externally added thereto and to transfer the toner image to a recording material, and includes a cleaning and lubricant-applying unit and a control unit configured to perform supply control.

The cleaning and lubricant-applying unit is configured to clean transfer residual toner on the image carrier and to apply the lubricant to the image carrier, and includes a blade configured to clean the transfer residual toner by coming into contact with the image carrier; a collected toner holding unit configured to hold collected toner including toner that has dropped from the blade; and a supply member capable of supplying the collected toner from the holding unit to a part of the image carrier, wherein the part of the image carrier is upstream of the blade with respect to the direction of rotation of the image carrier.

In addition, the supply control is such that when the image is printed at a coverage rate higher than a predetermined standard value, the supply is stopped or made smaller than that when the coverage rate is not higher than the standard value. Therefore, the image forming apparatus according to an embodiment of the present invention makes it possible to reduce coverage rate-dependent variations in the amount of the lubricant on the image carrier.

Even when the amount of the lubricant in the developing unit and thus the supply of the lubricant from the photoreceptor are reduced by continuous image printing at a low coverage rate, the lubricant is stably supplied to the blade by supplying the collected toner with the supply member so that the shortage of the lubricant can be prevented. On the other hand, when continuous image printing is performed at a high coverage rate, excessive supply of the lubricant can be prevented by stopping the supply member from supplying the lubricant or by making the amount of supply of the lubricant with the supply member smaller than that when printing is performed at a low coverage rate because the amount of supply of the lubricant from the photoreceptor is stabilized. When printing is performed at a low coverage rate, the collected toner should be supplied because no supply of the collected toner can cause the shortage of the lubricant. On the other hand, when printing is performed at a high coverage rate, the amount of supply of the collected toner should be reduced (or the supply of the collected toner should be stopped) because if the collected toner is supplied in the same way as when printing is performed at a high coverage rate, the supply of the lubricant can be excessive.

In the image forming apparatus according to a second embodiment, the control unit is configured to allow the apparatus to perform a first operation when the coverage rate is not higher than the standard value and configured to allow the apparatus to perform a second operation when the coverage rate is higher than the standard value, wherein the first operation includes performing the supply and the second operation includes collecting the transfer residual toner from the image carrier to the supply member. When image printing is performed at a very high coverage rate, the amount of the lubricant can be more stabilized regardless of coverage rate by performing a control for collecting the transfer residual toner.

This image forming apparatus has at least one of a charging unit configured to charge the toner on the image carrier before the collection and a charging unit configured to charge the toner on the supply member before the supply, wherein the control unit is configured to switch between the first operation and the second operation by switching the voltage of the supply member. The control of the electric field on the charged toner allows more reliable control of the amount of supply.

The image forming apparatus according to a third embodiment has a toner feed member configured to supply the collected toner to the supply member by rotating and coming into contact with the supply member, wherein the control unit is configured to perform the supply control by controlling at least one of switching between the rotation and stop of the toner feed member, the rotation speed of the toner feed member, and switching between contact and separation between the toner feed member and the supply member. The mechanical control of the amount of attachment of the toner allows the supply control without any toner charging member.

Although embodiments of the present invention have been described with reference to specific examples, such examples are not intended to limit the present invention. It will be understood that the present invention can be carried out in various specific modes without departing from the gist of the present invention.

The present invention is applicable to, for example, image forming apparatuses such as copying machines.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image forming apparatus comprising:
an image carrier configured to carry a toner image that is formed corresponding to an image using toner with a lubricant externally added thereto;
a transfer unit configured to transfer the toner image to a recording material;
a cleaning and lubricant-applying unit; and
a processor configured to perform supply control, wherein
the cleaning and lubricant-applying unit is configured to clean transfer residual toner on the image carrier and to apply the lubricant to the image carrier, and comprises a blade configured to clean the transfer residual toner by coming into contact with the image carrier, a collected toner holding unit configured to hold collected toner including toner that has dropped from the blade, and a supply member capable of supplying the collected toner from the holding unit to a part of the image carrier, wherein the part of the image carrier is upstream of the blade with respect to the direction of rotation of the image carrier, and
the processor is configured to perform control in such a manner that when the image is printed at a coverage rate higher than a predetermined standard value, the supply by the supply member is stopped or the amount of supply of the collected toner by the supply member is made smaller than that when the coverage rate is not higher than the standard value.

2. The image forming apparatus according to claim 1, wherein
the processor is configured to allow the apparatus to perform a first operation when the coverage rate is not higher than the standard value and configured to allow the apparatus to perform a second operation when the coverage rate is higher than the standard value, wherein the first operation comprises allowing the supply member to perform the supply and the second operation comprises collecting the transfer residual toner from the image carrier to the supply member.

3. The image forming apparatus according to claim 2, further comprising
at least one of a charging unit configured to charge toner on the image carrier before the collection and a charging unit configured to charge toner on the supply member before the supply, wherein
the processor is configured to switch between the first operation and the second operation by switching the voltage of the supply member.

4. The image forming apparatus according to claim 1, further comprising
a toner feed member configured to supply the collected toner to the supply member by rotating and coming into contact with the supply member, wherein
the processor is configured to control at least one of switching between rotation and stop of the toner feed member, the rotation speed of the toner feed member, and switching between contact and separation between the toner feed member and the supply member.
